(19) United States
(12) Patent Application Publication
(10) Pub. No.: US 2024/0069918 A1
(43) Pub. Date: Feb. 29, 2024

(54) METHOD AND SYSTEM FOR REPLICATING CORE CONFIGURATIONS

(71) Applicant: Cornami, Inc., Dallas, TX (US)

(72) Inventors: Yuri Victorvich, San Jose, CA (US); Frederick Furtek, Menlo Park, CA (US); Martin Alan Franz, II, Sunnyvale, CA (US); Paul L. Master, Sunnyvale, CA (US)

(21) Appl. No.: 17/893,993

(22) Filed: Aug. 23, 2022

(51) Int. Cl. G06F 9/38; G06F 9/50

(52) U.S. Cl. CPC G06F 9/3836; G06F 9/5044

(57) ABSTRACT

A system and method to efficiently configure an array of processing cores to perform functions of a program. A function of the program is converted to a configuration of cores. The configuration is laid out in a first subset of the array of cores. The configuration is stored. The configuration is replicated to perform the function on a second subset of the array of cores.

### TECHNICAL FIELD

The present disclosure relates generally to multi-core systems. More particularly, aspects of this disclosure relate to techniques to replicate configurations of groups of cores for programming of a massively parallel processing array.

### BACKGROUND

Computing systems are increasing based on homogeneous cores that may be configured for different executing applications. Massively parallel processing arrays (MPPA) are new class of hardware architectures which promise to enable stepping out of Moore's law, as data hungry applications seek performance beyond the memory wall limit. MPPAs side-step the input/output boundaries by providing copious amount of local memory and I/O so that computation is now CPU bound once again. The cores in a MPPA may be arranged in a grid and thus may be termed a grid computing device having a multitude of individual processing units or cores.

Thus, such cores may be adapted for many different operations and be purposed for various parallel programming tasks. The cores are typically fabricated on a die and may be referenced to as tiles. Such dies may be fabricated so they may be divided to allocate the needed processing power. Each of the cores in the grid are connected to some other cores into a multi-dimensional network. This maintains duplex data communication channels to the cores each of the cores are connected to. In such a structure, the cores typically form a 2-dimensional grid of cores each of which only have a limited number of neighboring cores that a core can communicate with. Such grid computing devices to achievement of computational performance that far exceed that of traditional Turing-style machines which generally perform only one or few operations at a time and can't scale any further beyond that.

However, programming of grid computing devices presents a significant challenge, typically far exceeding that of Turing-style machines. The challenge stems from the higher dimensionality of computational network cores, as for Turing-style machines only have one dimension, in contrast with two or more dimensions for grid computing devices.

The processing performed by such dies thus relies on many cores being employed to divide programming operations. One example of such division may be a streaming model of programming multiple cores that employs different threads that are assigned to different cores. The processing performed by such dies thus relies on many cores being employed to divide programming operations. One example of such division may be a streaming model of programming multiple cores that employs different threads that are assigned to different cores. Such use of numerous cores on one die or multiple dies on different chips may efficiently execute the program. For example, MPPA architecture can involve various computation modes including: (a) numeric, logic and math operations; (b) data routing operations; (c) conditional branching operations; and (d) implementations of all these operations in any or all data types such as Boolean, integer, floating point, or fixed-point types.

In order to efficiently execute an application, a software designer must configure the different cores to perform different program functions. However, this task becomes more complex as additional program functions are added. Further, unique functions performed by a set of configured cores may have to be employed repeatedly in a program. Since such a function is performed by the group at multiple intervals during execution, the demand for operations for the set of configured cores may cause bottlenecks in execution.

Thus, there is a need for duplicating core or tile configurations in a MPPA to provide more efficient execution of a program. There is a further need for a method to store different configurations for allocation of the cores in an array.

### SUMMARY

One disclosed example is a die having a plurality of processing cores and an interconnection network coupling the processing cores together. The die includes a configuration of a first subset of the processing cores to perform a function. The die includes a duplicate configuration of at least some of the other processing cores allocated to a second subset of the processing cores performing the function.

A further implementation of the example die is an embodiment where the processing cores are arranged in a grid. Another implementation is where the configuration includes a topology and interconnection of the first subset of some of the processing cores. The configuration is stored in on-die memory of the second subset of the processing cores to create the duplicate configuration. Another implementation is where the die includes a third subset of at least some of the processing cores to perform a second function on the processing cores. The die includes a duplicate configuration of at least some of the other processing cores allocated to a fourth subset of processing cores performing the second function. Another implementation is where each of the processing cores includes a memory, an arithmetic logic unit, and a set of interfaces interconnected to neighboring cores of the plurality of processing cores. Another implementation is where each of the processing cores are configurable to perform at least one of numeric, logic and math operations, data routing operations, conditional branching operations, input processing, and output processing. Another implementation is where the processing cores in the first subset are configured as wires connecting other processing cores in the first subset. Another implementation is where the configuration is produced by a complier compiling source code to produce the configuration. Another implementation is where the configuration is stored in a memory. The memory is one of a host server memory, an integrated circuit high bandwidth memory, or an on-die memory. Another implementation is where the duplicate configuration is configured in the second subset of the plurality of processing cores by copying the stored configuration from the memory to on-die memory of the second subset of the plurality of processing cores.

Another disclosed example is a system of compiling a program having at least one function on a plurality of processing cores. The system includes a compiler operable to convert the at least one function to a configuration of a first subset of processing cores in the processing cores and lay out the configuration of processing cores on a first subset of the array of processing cores. The system includes a structured memory to store the configuration of processing cores. The compiler replicates the stored configuration of processing cores on a second subset of the array of processing cores.

A further implementation of the example system is an embodiment where the structured memory is one of a host server memory, an integrated circuit high bandwidth memory, or an on-die memory. Another implementation is where the configuration of processing cores includes a topology and interconnection of the first subset of processing cores. The configuration is stored in on-die memory of the second subset of the processing cores.

Another disclosed example is a method of configuring an array of processing cores to perform functions of a program. A function of the program is converted to a configuration of a first subset of the array of processing cores. The first subset of the array of processing cores is configured according to the configuration. The configuration along with an identifier of the configuration is stored. The configuration to perform the function is replicated on a second subset of the array of cores.

A further implementation of the example method is an embodiment where the configuration includes topology and interconnection of the first subset of some of the processing cores. The configuration is stored in on-die memory of the second subset of the processing cores to create the replicated configuration. Another implementation is where the method further includes converting another function of the program to a second configuration of a third subset of the array of processing cores. The third subset of the array of processing cores is configured. The second configuration along with an identifier of the second configuration is stored. Another implementation is where each of the processing cores includes a memory, an arithmetic logic unit, and a set of interfaces interconnected to neighboring cores of the processing cores. Tach of the processing cores are configurable to perform at least one of numeric, logic and math operations, data routing operations, convolution, conditional branching operations, input processing, and output processing. Another implementation is where the configuration is converted by a complier compiling source code of the program. Another implementation is where the configuration is stored in one of a host server memory, an integrated circuit high bandwidth memory, or an on-die memory. Another implementation is where the duplicate configuration is configured in the second subset of the processing cores by copying the stored configuration from the memory to on-die memory of the second subset of the processing cores.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1A is a diagram of a chip having four dies each having multiple processing cores;

FIG. 1B is a simplified diagram of one of the dies on the chip shown in FIG. 1A;

FIG. 2A is a block diagram of the array of cores in the die in FIG. 1B;

FIG. 2B is a three-dimensional view of one section of the array of cores in the die in FIG. 1B;

FIG. 2C is a three-dimensional view of the entire array of cores in the die in FIG. 1B;

FIG. 3 is a flow diagram of a compiler routine for configuring cores in the die in FIG. 1B;

FIG. 4 is one configuration of cores to perform a one dimensional convolution function;

FIG. 5 is another configuration of cores to perform a matrix multiplication function;

FIG. 6 is a diagram showing the configurations in FIGS. 4 and 5 deployed on an example array of cores on a die;

FIG. 7A is a block diagram of an example neural network that may be executed by the array of cores; and

FIG. 7B is a diagram showing replications of the configurations in FIGS. 4-5 to streamline the execution of the neural network of FIG. 7A.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements, and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure is directed toward a system that allows reproduction of configurations for multi-core processor systems such as a grid computing device. The program for a grid computing device consists of a set of instructions assembled based on a solved problem. Such instructions are assigned to be performed by individual cores that they will run during the execution time. The configuration of the cores involves selecting the cores and activating interconnections between the cores for routing of data to perform the set of instructions. Once such configurations are established, the process may keep track of identically structured parts of the program for the grid computing device. The configurations of the individual cores are replicated for different functions when a program is compiled for configuration on a multi-core chip. This process allows simplification of the programming of such systems as previous configurations may be stored in different processor based, die based, or array based memories.

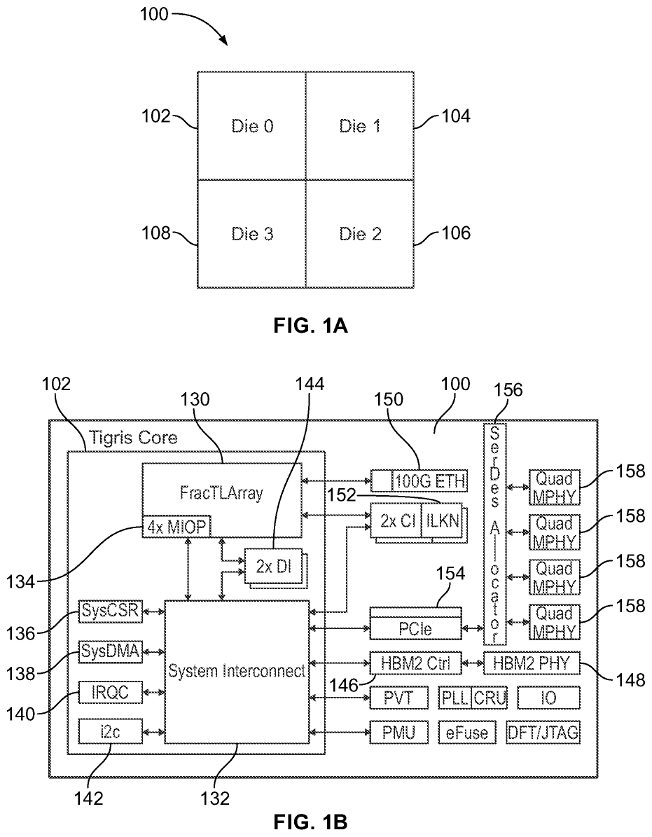

FIG. 1A shows an example chip 100 that is subdivided into four identical dies 102, 104, 106, and 108. Each of the dies 102, 104, 106, and 108 include multiple processor cores, support circuits, serial interconnections and serial data control subsystems. For example, the dies 102, 104, 106, and 108 may each have 4,096 processing cores as well as SERDES interconnection lanes to support different communication protocols. There are die to die parallel connections between the dies 102, 104, 106 and 108. Thus, each of the dies 102, 104, 106, and 108 in this example are interconnected by Interlaken connections. The chip 100 is designed to allow one, two or all four of the dies 102, 104, 106, and 108 to be used. The pins on a package related to un-used dies are left unconnected in the package or the board. The dies are scalable as additional chips identical to the chip 100 may be implemented in a device or a circuit board. In this example, a single communication port such as an Ethernet port is provided for the chip 100. Of course, other ports may be provided, such as one or more ports for each die.

FIG. 1B is a block diagram of one example of the die 102. The die 102 includes a fractal array 130 of processing cores. The processing cores in the fractal array 130 are interconnected with each other via a system interconnect 132. The entire array of cores 130 serves as the major processing engine of the die 102 and the chip 100. In this example, there are 4096 cores in the array 130 that are organized in a grid.

The system interconnection 132 is coupled to a series of memory input/output processors (MIOP) 134. The system interconnection 132 is coupled to a control status register (CSR) 136, a direct memory access (DMA) 138, an interrupt controller (IRQC) 140, an I2C bus controller 142, and two die to die interconnections 144. The two die to die interconnections 144 allow communication between the array of processing cores 130 of the die 102 and the two neighboring dies 104 and 108 in FIG. 1A.

The chip includes a high bandwidth memory controller 146 coupled to a high bandwidth memory 148 that constitute an external memory sub-system. The chip also includes an Ethernet controller system 150, an Interlaken controller system 152, and a PCIe controller system 154 for external communications. In this example each of the controller systems 150, 152, and 154 have a media access controller, a physical coding sublayer (PCS) and an input for data to and from the cores. Each controller of the respective communication protocol systems 150, 152, and 154 interfaces with the cores to provide data in the respective communication protocol. In this example, the Interlaken controller system 152 has two Interlaken controllers and respective channels. A SERDES allocator 156 allows allocation of SERDES lines through quad M-PHY units 158 to the communication systems 150, 152, and 154. Each of the controllers of the communication systems 150, 152, and 154 may access the high bandwidth memory 148.

In this example, the array 130 of directly interconnected cores are organized in tiles with 16 cores in each tile. The array 130 functions as a memory network on chip by having a high-bandwidth interconnect for routing data streams between the cores and the external DRAM through memory 10 processors (MIOP) 134 and the high bandwidth memory controller 146. The array 130 functions as a link network on chip interconnection for supporting communication between distant cores including chip-to-chip communication through an “Array of Chips” Bridge module. The array 130 has an error reporter function that captures and filters fatal error messages from all components of array 130.

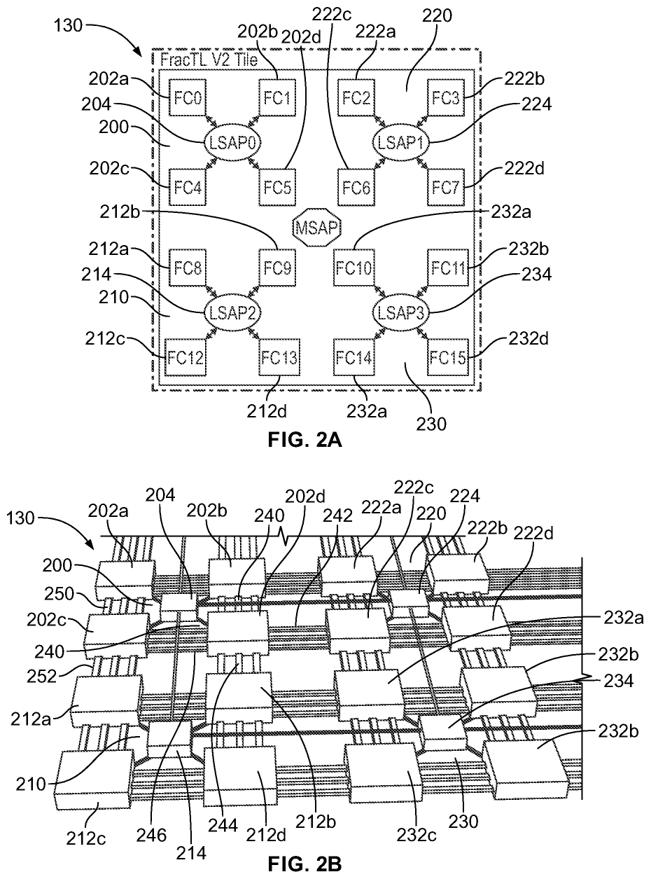

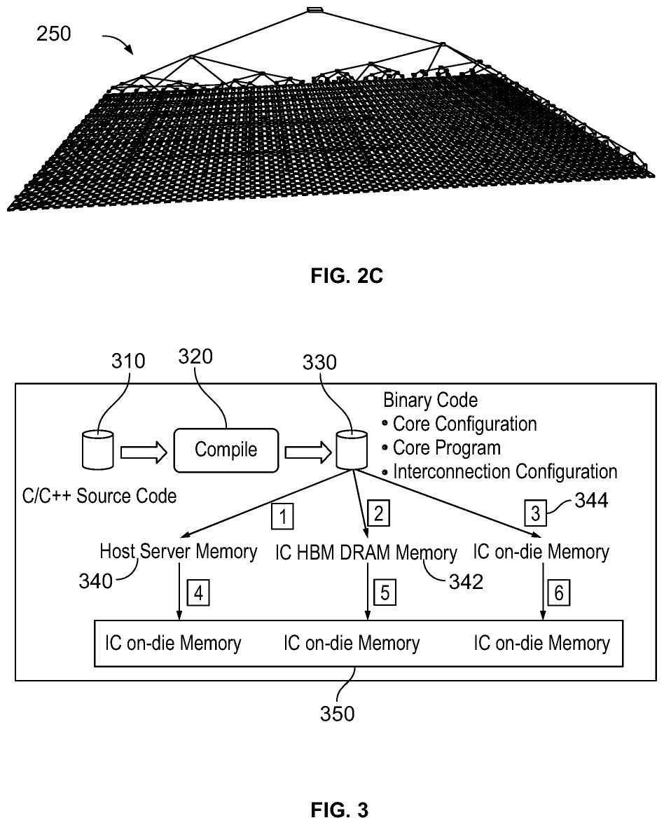

FIG. 2A is a detailed diagram of a section of the array of cores 130 in FIG. 1B. FIG. 2B is a three-dimensional image of the section of the array of cores 130 in FIG. 1B. The array of cores 130 is organized into four core clusters such as the clusters 200, 210, 220, and 230 shown in FIG. 2A. For example, the cluster 200 includes cores 202a, 202b, 202c, and 202d. Each of the four cores in each cluster 200 such as cores 202a, 202b, 202c, and 202d are coupled together by a router 204. FIG. 2B shows other clusters 210, 220, and 230 with corresponding cores 212a-212d, 222a-212d and 232a-232d and corresponding routers 214, 224, and 234.

As may be seen specifically in FIG. 2B, in this example, each of the cores 202a, 202b, 202c, and 202d has up to four sets of three interconnections. For example, a core in the center of the array such as the core 202d includes four sets of interconnections 240, 242, 244, and 246 each connected to one of four neighboring cores. Thus, core 202b is connected to the core 202d via the interconnections 240, core 202c is connected to the core 202d via the interconnections 242, core 212b is connected to the core 202d via the interconnections 244, and core 202c is connected to the core 202d via the interconnectors 246. A separate connector 248 is coupled to the wire router 204 of the cluster 200. Thus each core in the middle of the array, has four sets of interconnections, while border cores such as the core 202c only have three sets of interconnections 250, 252, and 246 that are connected to respective cores 202a, 202d, and 212a.

FIG. 2C is a perspective view of all of the cores 250 of the array of cores 130, which is a grid computing device as the cores are arranged in a grid. Each of the cores in the array of cores 130 includes an arithmetic logic unit (ALU), a memory such as SRAM, inner-connectivity to neighboring cores, and outer connectivity to devices outside of the array of cores 130. Selected groups of cores in the array of cores 130 may be configured to perform specific functions. Other selected groups may be configured for other specific functions. Each of the cores in the configuration are programmed to perform functions such as numeric, logic and math operations, data routing operations, conditional branching operations, input processing, output processing, and being a “wire” (serving as a connector) between other cores. Data may be exchanged between the cores in the array of cores 130 through the interconnections between the cores and the router structures explained above. The data may include any or all data types such as Boolean, integer, floating point, or fixed-point types. The disclosed method allows identical groups of cores that are configured as a group to perform a programming operation or function to be replicated over the array of cores 130, rather than relying on an overall layout for each time the function is required in the overall configuration of all of the cores in the array of cores 130.

Programs may be compiled for configuring different cores from the array of cores 130. FIG. 3 shows a diagram of the compilation process performed by a complier system to produce configuration data. A traditional set of programming code 310 is provided such as in C or C++ programming code. A compiler 320 converts the programming code 310 in configuration data for the cores. Such programming involves the complier 320 converting source code of a program to different configurations of the cores. The example compiler 320 translates the source code into layouts of the processing cores necessary to execute the operations of the source code. The compiler 320 executes compiler tools such as a place and route tool routine that provides a topology for placement of the cores in the array of cores 130 and interconnections between the placed cores for the desired operation. The compiler 320 thus creates binary code 330 that includes the core configuration, core program, and interconnection configuration for the cores that perform the source code functions.

Alternatively, the topology may be prepared by an expert user manually and stored by the compiler system. Once all the operations are placed and routed on the array of cores 130, the compiled program may be executed by the configured cores.

The configurations constitute individual uniquely-structured parts of the source code program. The configurations can be tracked by being stored in a specially constructed memory structure that allows efficient indexing and identification based on their graph-theoretical characteristics like caninic graph hash, among others. As shown in FIG. 3, the resulting configuration data may be stored in different types of memories. The speed of the configuration depends on the memory that stores the configuration data. Thus, the output binary code 330 may be stored either on a host server memory 340, an integrated circuit high bandwidth memory 342, or an on-die memory 344. As will be explained additional cores may be configured using the stored configuration data by copying the stored binary code 330 to on-die memory 350 of another set of processing cores.

Once the configurations are established, the individual uniquely-structured program block of the configuration block can be mapped onto the cores individually. This mapping can be efficiently reused for all instances of such blocks by copying the configuration data from one of the memories in FIG. 3. The individual block layouts can be efficiently stored together with the blocks themselves in a memory structure. The block configurations and core configurations stored in the memory structure can greatly simplify programming of grid computing devices by avoiding repetitive expensive multi-dimensional block mapping operations. This can greatly reduce both CPU time and complexity of programming multi-dimensional grid core devices.

The type of memory device used for storage of the memory structure controls the speed of programming or reprogramming cores for performing the desired function. In replication of core configurations where speed is not a requirement, the configurations may be stored in the host server memory 340 and copied to on-die memory for configuring or reconfiguring a group of cores in seconds. Configuration codes stored in the integrated circuit high bandwidth memory 342 may be more rapidly deployed to the on-die memory to configure or reconfigure a group of cores in milliseconds. Real-time configuration or reconfiguration of cores in microseconds may be accomplished by storing and copying the configuration codes stored on the on-die memory 344 to other on-die memory. Thus, use of the high bandwidth memory 342 results in configuration approximately 1,000 times as fast as configuration from the host server memory. Use of the on-die memory results in configuration approximately one million times as fast as configuration from the host server memory.

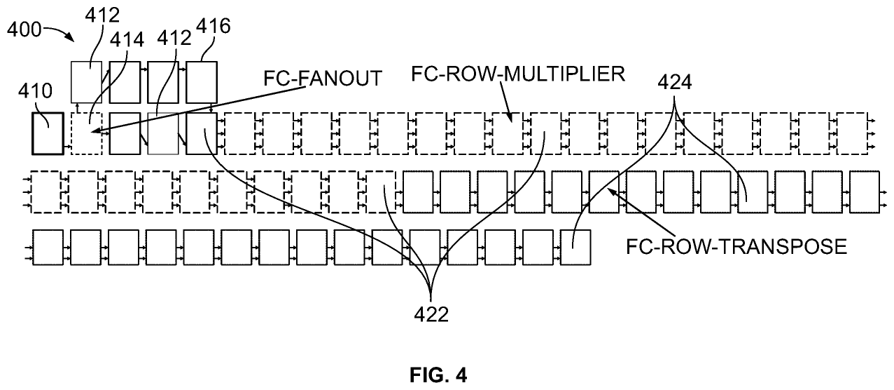

An example of a group of cores that may be configured for a function may be shown in a configuration 400 in FIG. 4. The configuration 400 allows one dimensional convolution operations such as that performed by a layer of a convolutional neural network model. For example, convolutional layers of the convolutional neural network may be output as a matrix through the evaluation of input values and weights. The configuration 400 requires a certain number of cores in the array of cores 130 and thus the configuration 400 encompasses a layout of a subset of the cores in the array of cores 130.

One of the cores in the configuration 400 is configured as an input interface 410 to accept the input values for the convolution function. Two of the cores are configured as first in first out (FIFO) buffers 412 for different inputs to the configuration 400. One of the cores is configured for a fractal core fanout 414 that converts the one dimensional data (weights and inputs) into a matrix format. Several additional cores 416 serve as connectors or wires between other cores in the layout 400.

In this example, the inputs constitute two matrix sizes (M×N) and (N×P) for the inputs and weights respectively for the convolution operation. One set of cores 422 each serve as a fractal core row multiplier. Another set of cores each constitute a fractal core row transposer 424. Thus, each of the row multipliers 422 provide multiplication and the row transposers 424 transpose the results to rows in the output matrix. In this example the output matrix is 28×28, and thus 28 cores are used for the row multipliers 422 and 28 cores are used for the row transposers 424.

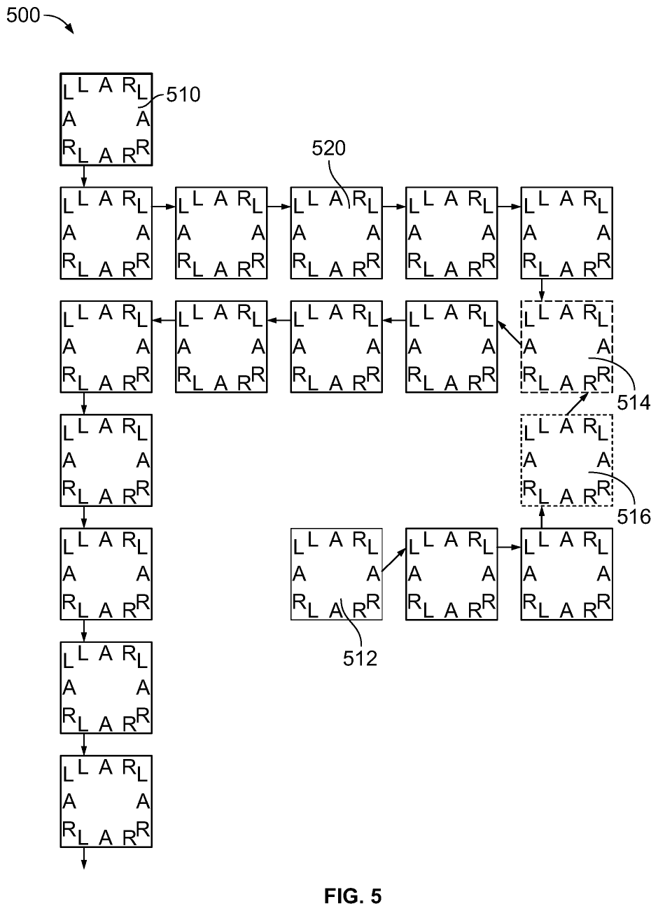

FIG. 5 shows another example group of core configuration 500 for the function of simple matrix function. The core configuration 500 includes a core 510 configured as a constant circular buffer generator. Another core 512 is configured as a TSA source/input. Another core 514 is configured as a minimum function and a core 516 is configured as a copy L to aggregate function. A series of wire cores 520 allows data to be exchanged between the configured cores.

A program may be compiled to be executed by the array of cores 130 in FIGS. 1-2. The program includes different functions that may be configured using the cores in the array of cores according to a set topology or configuration of certain numbers of the cores in the array of cores 130 to perform the function. Each function is thus allocated certain core configurations that communicate with other configurations to perform the operations required in the program. For example, a program may require matrix multiplication and thus require at least one configuration of cores in the array of cores 130 similar to the layout 400. Other example functions may include Fast Fourier Transform (FFT) functions, Number Theoretic Transform (NTT) functions, ASCII Search, tangential functions, division and other mathematical functions, and Boolean functions.

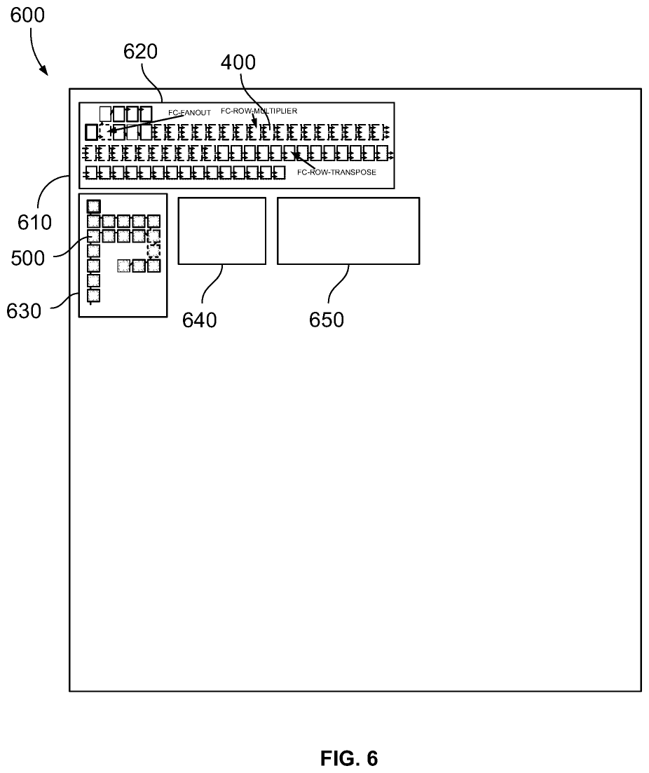

FIG. 6 is a core layout diagram 600 showing the configurations in FIGS. 4 and 5 deployed on an example array of cores 610 on a die to implement functions in a program. In this example, the array of cores 610 includes a grid of 4,096 total cores similar to the dies shown in FIGS. 1-2. The configuration 400 from FIG. 4 has been allocated a certain subset of cores in an area 620 from the array of cores 610. Similarly, the configuration 500 in FIG. 5 has been allocated a certain number of cores in another area 630 in the array of cores 610. Other functions of the program may be configured in different areas of the array 610 such as areas 640 and 650.

The configuration 400 may be connected to cores of other configured functions through the internal routers on the array of cores 610. Thus, data may be exchanged with other configured cores that are performing program functions, such as the configuration 500. Two other configurations are assigned areas 640 and 640 in the array of cores 610. The configurations 400 and 500 and the configurations in the areas 630 and 640 may be accessed by a compiler to be assigned to perform functions required by the program. For example, when the program requires convolution, data is routed to the configuration 500 each time the function is required.

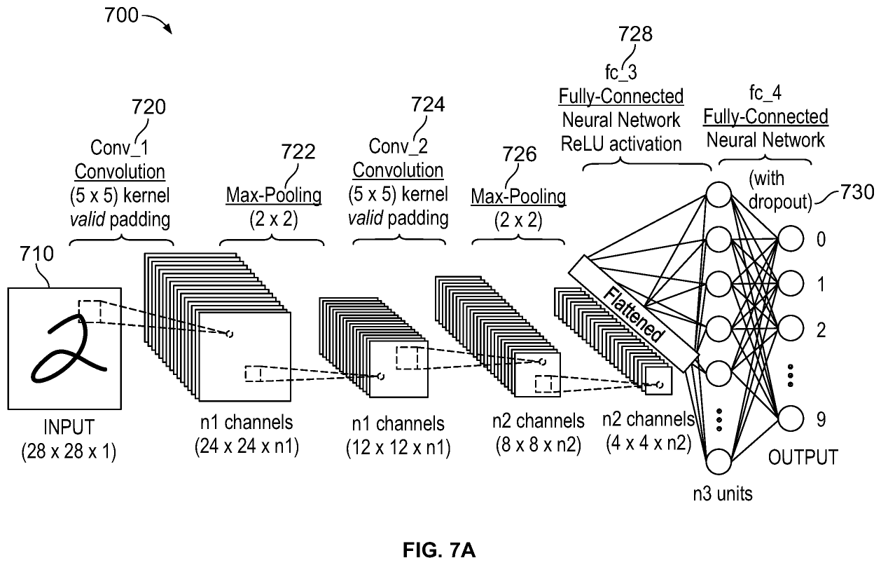

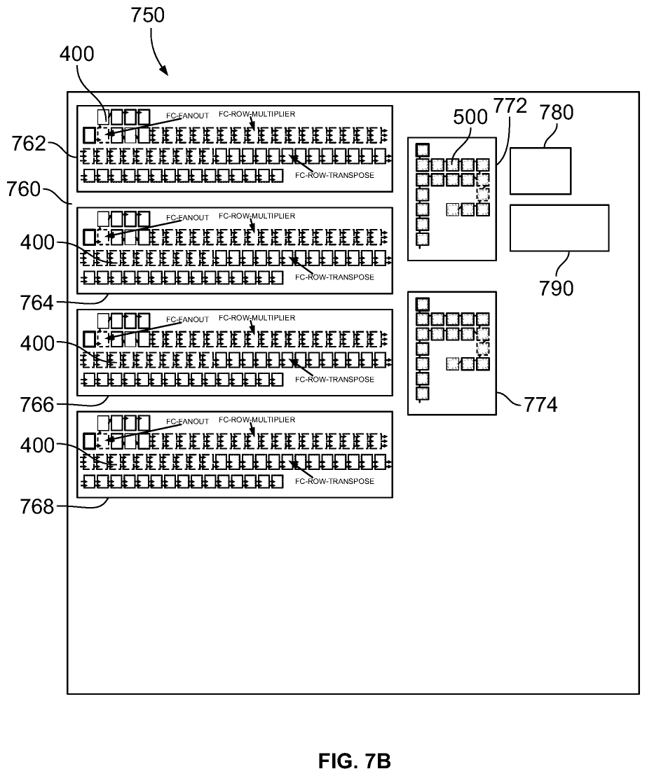

In this example, when the configurations of cores are established for different program functions, the core area and corresponding interconnections and programming of each core is stored in memory. The stored configurations may then be replicated to allow other areas of the array of cores to be configured for the particular function of a stored configuration. Thus, after the initial configurations 400 and 500 are placed on the array of cores 610, the compiler may keep track of the locations (via coordinates of the areas on the array of cores 610). The location information may then be used to build memory maps of the configurations. The memory maps may be then used to replicate the desired configurations to perform the functions for the program or other programs that may use the same functions. An example of a program function is shown in FIG. 7A. FIG. 7A shows a convolutional neural network 700 which can take in an input image 710, assign importance (learnable weights and biases) to various aspects/objects in the image and be able to differentiate images. In this example, the convolutional neural network 700 performs image recognition from an image 710 that provides the input. The network 700 performs a first set of convolutions 720 to extract low level features from the image 710. The results of the convolutions 720 is sent to a pooling layer 722 to reduce the spatial size of the convolved features. A second set of convolutions 724 is performed to extract high level features. The results of the convolutions 724 is sent to a pooling layer 726 to reduce the spatial size of the convolved features.

A fully connected layer 728 learns non-linear combinations of the high-level features as represented by the output of the convolutional layer 724. The resulting image is flattened into a column vector and fed into a feed-forward neural network 730.

FIG. 7B is a layout diagram 750 showing replications of the configurations in FIGS. 4-5 to streamline the execution of the example convolutional neural network 700. The layout 750 includes different areas of an array of cores 760 that are allocated according to the example program. In this example, there four areas 762, 764, 766, and 768 dedicated to configuration for the convolution functions for the convolution layers 720 and 724. There are two areas 772 and 774 dedicated to configurations for the matrix functions used for the pooling layers 722 and 726. [IS THIS RIGHT???] Additional areas 780 and 790 are allocated for cores configured for other functions of the neural network.

In this example, the layout 750 includes four sets of the replicated convolution configurations 400 in FIG. 4 and two sets of matrix multiplication of the configurations 500 in FIG. 5. In this example, the configuration 400 has been assigned the first area 762 in the array of cores 760. The configuration 400 is replicated and then assigned to three additional areas 764, 766 and 768. In this manner, if the matrix multiplication function is simultaneously performed by the program, bottlenecks may be avoided since the function may be performed simultaneously for up to four different operations. Similarly, the configuration 500 is assigned to a first area 772 and replicated to be assigned to another area 774. When the operation performed by the configuration 500 occurs simultaneously in the program, bottlenecks may be avoided by performing the operation by the configurations 500 in the areas 772 and 774.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

1. A die comprising:
a plurality of processing cores;
an interconnection network coupling the plurality of processing cores together;
a configuration of a first subset of at least some of the plurality of processing cores to perform a function on the plurality of processing cores; and
a duplicate configuration of at least some of the other plurality of processing cores allocated to a second subset of the plurality of processing cores performing the function.

2. The die of claim 1, wherein the plurality of processing cores are arranged in a grid.

3. The die of claim 1, wherein the configuration includes a topology and interconnection of the first subset of some of the plurality of processing cores, and wherein the configuration is stored in on-die memory of the second subset of the plurality of processing cores to create the duplicate configuration.

4. The die of claim 1, further comprising:
a third subset of at least some of the plurality of processing cores to perform a second function on the plurality of processing cores; and
a duplicate configuration of at least some of the other plurality of processing cores allocated to a fourth subset of the plurality of processing cores performing the second function.

5. The die of claim 1, wherein each of the processing cores includes a memory, an arithmetic logic unit, and a set of interfaces interconnected to neighboring cores of the plurality of processing cores.

6. The die of claim 1, wherein each of the processing cores are configurable to perform at least one of numeric, logic and math operations, data routing operations, conditional branching operations, input processing, and output processing.

7. The die of claim 1, wherein the processing cores in the first subset are configured as wires connecting other processing cores in the first subset.

8. The die of claim 1, wherein the configuration is produced by a complier compiling source code to produce the configuration.

9. The die of claim 1, wherein the configuration is stored in a memory, wherein the memory is one of a host server memory, an integrated circuit high bandwidth memory, or an on-die memory.

10. The die of claim 9, wherein the duplicate configuration is configured in the second subset of the plurality of processing cores by copying the stored configuration from the memory to on-die memory of the second subset of the plurality of processing cores.

11. A system of compiling a program having at least one function on a plurality of processing cores, the system comprising:
a compiler operable to convert the at least one function to a configuration of a first subset of processing cores in the plurality of processing cores and lay out the configuration of processing cores on a first subset of the array of processing cores; and
a structured memory to store the configuration of processing cores, wherein the compiler replicates the stored configuration of processing cores on a second subset of the array of processing cores.

12. The system of claim 11, wherein the structured memory is one of a host server memory, an integrated circuit high bandwidth memory, or an on-die memory.

13. The system of claim 11, wherein the configuration of processing cores includes a topology and interconnection of the first subset of processing cores, and wherein the configuration is stored in on-die memory of the second subset of the plurality of processing cores.

14. A method of configuring an array of processing cores to perform functions of a program, the method comprising:
converting a function of the program to a configuration of a first subset of the array of processing cores;
configuring the first subset of the array of processing cores according to the configuration;
storing the configuration along with an identifier of the configuration; and
replicating the configuration to perform the function on a second subset of the array of cores.

15. The method of claim 14, wherein the configuration includes topology and interconnection of the first subset of some of the plurality of processing cores, and wherein the configuration is stored in on-die memory of the second subset of the plurality of processing cores to create the replicated configuration.

16. The method of claim 14, further comprising:
converting another function of the program to a second configuration of a third subset of the array of processing cores;
configuring the third subset of the array of processing cores; and
storing the second configuration along with an identifier of the second configuration.

17. The method of claim 14, wherein each of the processing cores includes a memory, an arithmetic logic unit, and a set of interfaces interconnected to neighboring cores of the plurality of processing cores, and wherein each of the processing cores are configurable to perform at least one of numeric, logic and math operations, data routing operations, convolution, conditional branching operations, input processing, and output processing.

18. The method of claim 14, wherein the configuration is converted by a complier compiling source code of the program.

19. The method of claim 14, wherein the configuration is stored in one of a host server memory, an integrated circuit high bandwidth memory, or an on-die memory.

20. The method of claim 19, wherein the duplicate configuration is configured in the second subset of the plurality of processing cores by copying the stored configuration from the memory to on-die memory of the second subset of the plurality of processing cores.
